(19) United States
(12) Patent Application Publication
(10) Pub. No.: US 2005/0071512 A1
(43) Pub. Date: Mar. 31, 2005

(54) System for Interfacing software programs

(76) Inventors: Donte Kim, Alta Loma, CA (US); Nathan Leach, Stevenson Ranch, CA (US)

Correspondence Address: Sung I. Oh, Esq.;Squire, Sanders & Dempsey, L.L.P., 14th Floor, 801 S. Figueroa Street, Los Angeles, CA, 90017, US

(21) Appl. No.: 10/624,412

(22) Filed: Jul. 21, 2003

Related U.S. Application Data
(60) Provisional application No. 60/397,737, filed on Jul. 22, 2002.
(60) Provisional application No. 60/455,008.

(51) Int. Cl. G06F 3/00

(52) U.S. Cl. 710/1

(57) ABSTRACT

This invention relates to a credit card processing system that integrates between a variety of application software and a variety of processing engines. This allows companies the freedom to choose the method of communicating, technology, and price point that meet their needs based on the volume of credit card transactions. This may be accomplished by “wrapping” various processing engines with a unified standard to eliminate the need for the client to integrate certain processing engines that do not support certain processors.

### RELATED APPLICATION

This application claims priority to two U.S. provisional applications: (1) U.S. Provisional Application No. 60/397,737, filed Jul. 22, 2002, entitled System for Processing Electronic Payment Transactions In Multiple Data Formats; and (2) U.S. Provisional Application No. 60/455,008, filed Mar. 14, 2003, entitled System for Interfacing Software Programs, which are both incorporated by reference.

### BACKGROUND OF THE INVENTION

1. Field of the Invention

This invention provides a system capable of interfacing software programs with different data format requirements. In particular, the system is capable of interfacing electronic payment transactions between an application program and a number of payment processors having different data formatting requirements to process the transaction.

3. Background

When a customer uses a credit card to make purchases with a merchant, a number of steps need to take place before a transaction can be completed. To begin, the merchant obtains the credit card information from the customer to process the transaction. Based on the credit card information, the merchant requests an authorization from a payment processor for the transaction. The authorization is a process of validating the status of the credit card and reserving sufficient funds to cover the amount in the transaction. The payment processor is a third-party organization that provides an authorization code for each of the transactions and settles the transaction once the merchant provides the service or the goods to the customer.

The merchant has many payment processors from which to choose from to process the credit card transactions. For example, Verisign®, Paymentech®, Tranvia®, and Nova® are a few of the companies that offer payment processing services. Each of these companies offers different fee arrangements to entice the merchant to conduct the transactions through its payment processor. Besides the different fee structures, different payment processors have different requirements in the way that data needs to be formatted in order to process the transaction. Each payment processor may require that information be fielded differently, requiring certain information in certain order. For instance, a first payment gateway may require fields in the following order: the first field being the type of credit card being used, i.e., VISA, MASTER CARD, or DISCOVER CARD; the second field being the credit card number; the third field being the cardholder's name; and the fourth field being the expiration date; in order to process the transaction. A second payment processor, however, may require the first field to be the cardholder's name; the second field to be the type of credit card; the third field to be the expiration date; and the fourth field to be the credit card number; and also ask for a CCV number for security. This means that the merchant's system that processes the credit card transaction needs to be revised or tailored so that the data is formatted and transmitted correctly to meet the data formatting requirements for that particular payment processor to process the transaction. For merchants, having different data formatting requirements is a drawback because should the merchant decide to later switch to a different payment processor, the merchant's accounting software system may need to be reprogrammed to interface with the new data formatting requirements. This can take both time and money to implement.

To interface the merchant's accounting package system with a payment processor, the merchant usually has two options. The first option is to have a customized payment system developed specifically for the merchant to allow direct credit card transaction with the payment processor or bank. The merchant usually runs the customized payment system on its own server developed by a specialized vendor. Developing customized software for a payment system can be expensive and time consuming. With the changes in technology, updating and maintaining the payment system can be expensive and time consuming as well.

The second option for the merchant is to use the services of a third-party gateway. The third-party gateway processes payments by providing an interface between the merchant's accounting system and the payment processor, effectively acting as a hub, forwarding information to a specific payment processor. With the second option, there are, however, two fees for every transaction: one fee to the payment processor and the second fee to the third-party gateway. Even with the third-party gateway, the merchant may still need technical staff to integrate the third-party gateway program with the merchant's accounting package. In most instances, the third-party gateway will provide the merchant with a software development kit (SDK) that allows the merchant's accounting package to interface with the third-party gateway software and the payment processor. Implementing the SDK, however, can take up to six weeks. As such, most merchants are reluctant to switch to another payment processor even if better fee arrangements are offered. Thus, there is still a need for an electronic payment system that can process electronic payment transactions in multiple formats and communicate with many different payment gateways, whether they are gateways, processors, or banks.

### INVENTION SUMMARY

The invention provides an electronic payment system that consolidates data formats, input fields, and transmission requirements for interacting with different payment systems such as gateways, processors, and banks. The electronic payment system may support many different types of payment gateways each with its own data formatting, transmission, and input field requirements and provides payment connectivity over electronic networks between buyers, sellers, and financial networks.

The electronic payment system may also provide an application programming interface (API) that allows application software developers and users to connect to different payment gateways. The application software may be an e-commerce website, an accounting program, an e-commerce website development tool, a point of sale system, and/or any other electronic system known to one in the art to process electronic payment transactions. The API may allow a user or a developer a choice between multiple gateways, processors, and/or banks, so that when a payment gateway is selected, the appropriate input fields distinguishable between required and optional input fields, data formatting, and transmission requirements are met so that the application software can interface with the payment gateway.

Many modifications, variations, and combinations of the methods and systems of processing electronic payment transactions are possible in light of the embodiments described herein. The description above and many other features and attendant advantages of the present invention will become apparent from a consideration of the following detailed description when considered in conjunction with the accompanying drawings.

### BRIEF DESCRIPTION OF THE FIGURES

A detailed description with regard to the embodiments in accordance with the present invention will be made with reference to the accompanying drawings.

FIG. 1 illustrates a system diagram including an application programming interface (API) capable of interfacing application software with many different types of payment gateways by wrapping around a software object for each payment gateway.

FIG. 2 illustrates a flowchart for installing an API and connecting to many different types of payment gateways.

FIG. 3 illustrates a system diagram where application software interfaces with an API.

FIG. 4 illustrates an interfacing system including the application programming interface capable of processing credit card transactions for merchants using different application software or systems to process the transactions.

### DETAILED DESCRIPTION

This following description should not be taken in a limiting sense but is made merely for the purpose of illustrating the general principles of the invention. The section titles and overall organization of the present detailed description are for purposes of convenience only and are not intended to limit the present invention.

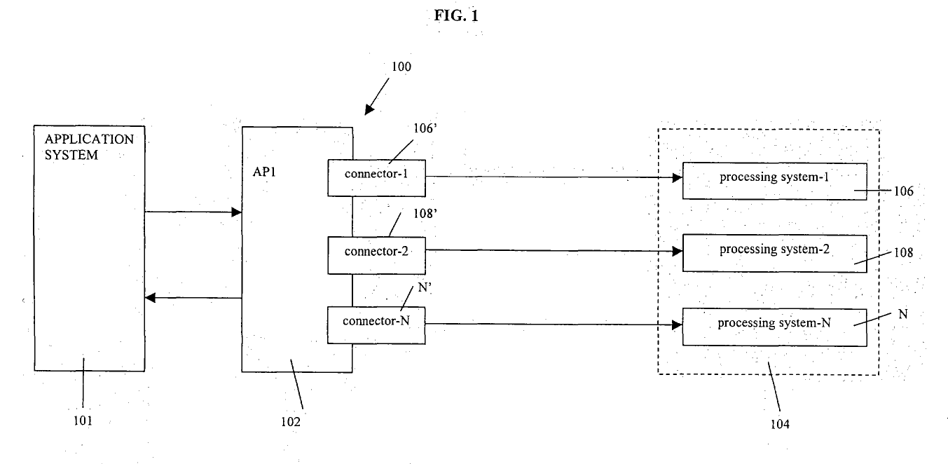

FIG. 1 illustrates an interface system 100 including an application program interface (API) 102 capable of interfacing an application system 101 with a plurality of processing systems 104. The application system 101 and the plurality of processing systems 104 may be any type of software that needs to interface to process the transactions. The plurality of processing systems 104 may include a processing system_1, processing system_2, and processing system_N, where N denotes the number of processing systems within the plurality of processing systems 104. That is, N may be any integer. Each processing system 104 may have different requirements in the way that data needs to be formatted in order to process the transaction with the application system 101. For instance, the processing system_1 may request the data_1 in the first field, data_2 in the second field, data_3 in the third field and etc. In contrast, the processing system_2 may request the data_2 in the first field, data_3 in the second field, and data_1 in the third field.

Another difference in data formatting requirements may be that the processing system_1 and processing system_2 may request different fields. For instance, out of possible one hundred fields, the processing system_1 may request the following fields: field _1 field_3, field_5, field_7, field_8, field_9, field_11, field_12, field_13, field_15, field_25, field_26, field_40 and etc., to process the transaction with the application system 101. In contrast, the processing system_2 may request some common and different fields such as field_1, field_3, field_13, field_15, field_25, field_26 and etc. In this example, the same input fields for the processing system_1 and processing system_2 may share the same value or data. In addition, as the plurality of processing systems 104 are updated from time to time, the data formatting requirements may change to process the data. This means that the application software 101 may not be able to directly interface with the plurality of system 104.

Besides the different formatting requirements, each processing system may have different required fields and optional fields to process the transaction. For instance, the processing system_1 may require field_1 field_2, field_15, and field_40 with the other input fields being optional to process the transaction. The processing system_2 on the other hand may require field_1, field_2, and field_15 with all other input fields being optional. That is, the data for the required fields are needed to process the transaction, but the optional are not, although it may be useful in processing the transaction more efficiently and securely.

The API 102 interfaces the application system 101 with the plurality of processing systems 104. The API 102 is communicateably coupled to connector_1, connector_2, and connector_N corresponding to the processing system_1, processing system_2, and processing system_N, respectively. Each connector is stored with the data formatting requirements in order for the processing system corresponding to the connector to process the data. For instance, connector_1 may be stored with the formatting requirements that the following input fields are requested by the processing system_1: field_1, field_3, field_5, field_7, field_8, field_9, field_11, field_12, field_13, field_15, field_25, field_26, field_40 and etc. In addition, connector_1 may be stored with information that the following input fields are required: field_1, field_2, field_15, and field_40, while all other input fields are optional. Likewise, connector_2 may be stored with the formatting requirements for the processing system_2 that the following input fields are requested by the payment system_2: field_1, field_3, field_13, field_15, field_25, field_26 and etc, and that input fields field_1, field_2, and field_15 are required.

The application system 101 based on a predetermined set of rules may instruct the API 102 which connector to use. For example, the predetermined set of rules may be: if value or data for input field_15>0, then connector_1 is used, but if not, then connector_2 is used. Based on the connector information from the application system 101, the API 102 accesses the corresponding connector and retrieves the formatting requirements stored in that connector corresponding to the processing system. For instance, if the application system 101 instructs the API 102 to use connectors, the API retrieves the formatting requirements stored in connector_1 and forwards the formatting requirements to the application system 101. Based on the formatting requirements, a quarry is made through the application system 101 to request from the user to input the data or value for the input fields: field_1, field_3, field_5, field_7, field_8, field_9, field_11, field_12, field_13, field_15, field_25, field_26, field_40 and etc. In a quarry may distinguish the required field(s) from the optional field(s) to efficiently and securely process the transaction. The API then retrieves data or value for the input fields corresponding to connector_1 and forwards the information to the processing system_1 for processing the transaction. Accordingly, with the connectors corresponding to the processing systems, the API 102 may interface one software system with another software system having different data formatting requirements.

The API 102 may operate within the server hosting the application system 101 or operate from a remote server. The API 102 may be any type of interfacing object known to one in the art, such as, but not limited to, a .COM object, a .NET program, or any type of software library, etc., used to facilitate the interaction of programs with each other. The connectors may be software objects with the data formatting requirements for the corresponding processing system within the plurality of processing systems 104.

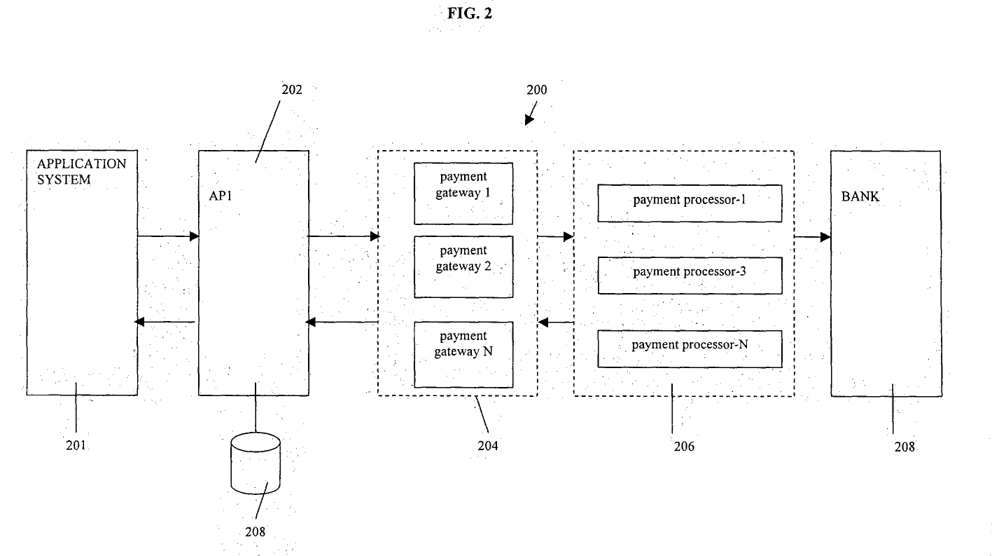

FIG. 2 illustrates an interfacing system 200 including an API 202 for processing transactions related to credit cards. Residing between the application system 201 and the plurality of payment gateways 204 is the API 202 that allows a merchant to select which payment gateway to use in order to process the transaction with the payment processor 206. During the initial setup to link the application system 201 to the API 202, the API 202 provides a menu with the list of payment gateways 204 that are supported by the API 202. For each payment gateway, a corresponding connector may be stored in the connector memory 208 with the data formatting requirements for the payment gateway. For example, connectors_1 connector_2, and connector_N may be stored in the connector memory 208 with the data formatting requirements for payment gateway_1, payment gateway_2, and payment gateway_N, respectively. The merchant may select more than one payment gateway to process the transaction through a particular payment gateway based on a predetermined condition. The merchant may also later change the payment gateway to process the credit card transaction by selecting another payment gateway that is supported by the API 202.

The application system 201 is on the merchant side to accept the credit card information. For instance, the application system 201 may be an e-commerce website, an accounting program, a point-of-sale (POS) system, credit card swapper, business-to-business (B2B) portals, call centers, enterprise resource planning (ERP), customer relationship management (CRM), or any other electronic system known to one in the art for processing electronic payment.

The API 202 may be coupled to the connector memory 208 to have access to connector_1, connector_2, and connector_N corresponding to the payment gateway_1, gateway_2, and gateway_N, respectively. Each connector includes data formatting information with regard to which input fields are requested. In addition, the connector may distinguish which fields are required and optional. For example, Table A below may illustrate the input fields information requested from the user to process a credit sales transaction through the payment gateway_1. As such, the input fields information in Table A may correspond to connector_1:

TABLE A

| Field ID | Field Name | Field Decryption | Required |
|---|---|---|---|
| Field_1 | AccountNum | Credit Card Number | Yes |
| Field_3 | Exp | Expiration Date MMYY | Yes |
| Field_5 | AVSname | Card Holder First Name | No |
| Field_7 | AVSname | Card Holder Last Name | No |
| Field_8 | AVSaddress1 | Card Holder Address 1 | No |
| Field_9 | AVSaddress2 | Card Holder Address 2 | No |
| Field_11 | AVScity | Card Holder City | No |
| Field_12 | AVSstate | Card Holder State | No |
| Field_13 | AVSzip | Card Holder Zip | No |
| Field_15 | Amount | Transaction Amount | Yes |
| Field_25 | Comments | User Comment 1 | No |
| Field_26 | Comments | User Comment 2 | No |
| Field_40 | OrderID | Invoice Number | Yes |
| Field_72 | ECOrderNum | EC Order Number | No |
| Field_73 | TzCode | Time Zone | No |
| Field_74 | CurrencyCode | Currency Code | No |
| Field_75 | CurrencyExponent | Currency Exponent | No |
| Field_76 | TxDateTime | Transaction Date | No |
| Field_77 | ShippingRef | Shipping Reference | No |
| Field_78 | CardSecVaI | Card Section Value | No |
| Field_79 | MessageType | Message Type | No |

In connector_1, the following input fields are required: field_1, field_3, field_15, and field_40, and all other input fields may be optional. Different payment gateway may request different input fields. For example, Table B below illustrates the different input fields request for payment gateway_2. As such, the input fields information in Table B corresponds to connector_2:

TABLE B

| Field ID | Field Name | Field Decryption | Required |
|---|---|---|---|
| Field_1 | ACCT | Credit Card Number | Yes |
| Field_3 | EXPDATE | Expiration Date MMYY | Yes |
| Field_13 | ZIP | Card Holder Zip | No |
| Field_15 | AMT | Transaction Amount | Yes |
| Field_25 | COMMENT1 | User Comment 1 | No |
| Field_26 | COMMENT2 | User Comment 2 | No |
| Field_34 | PONUM | PO Number | No |
| Field_35 | DESC | General Description | No |
| Field_36 | DESC1 | General Description 1 | No |
| Field_37 | DESCZ | General Description 2 | No |
| Field_38 | DESC3 | General Description 3 | No |
| Field_39 | DESC4 | General Description 4 | No |
| Field_40 | INVNUM | Invoice Number | No |
| Field_41 | SHIPTOZIP | Ship to Zip | No |
| Field_42 | TAXAMT | Tax Amount | No |
| Field_55 | COMMENT3 | Account Holder Street | No |

Tables A and B illustrate that each payment gateway may request different input fields and designate different required fields. In this example, the input field_40 that is required for connector_1 may not be requested by connector_2.

Still further, connector_1 may have different formatting requirements from connector_2 in the following ways: The connector_1 may require the following input fields with the following data: the first field corresponding to data_1=first name; the second field corresponding to data_2=last name; the third field corresponding to data_3=the type of credit card, such as Visa® or Master Card®; the fourth field corresponding to data_4=credit card number; the fifth field corresponding to data_5=CCV number; the sixth field corresponding to data_6=expiration date of the credit card; and the seventh field corresponding to data_7=zip code of the billing address of the credit card. The payment server 206 may not require all seven input fields to process the transaction. For instance, the payment server 206 may only require the first, second, third, fourth, and sixth fields to process the transaction, but the fifth and seventh input fields may be further requested as optional fields to improve the efficiency in processing the transaction or for security reasons. In contrast, the connector_2 may require the following input fields corresponding to the following data: the first field corresponding to data_3, which is a type of credit card used for the transaction; the second field corresponding to data_4; the third field corresponding to data_1; the fourth field corresponding to data_2, the fifth field corresponding to data_5—CCV number; and the sixth field corresponding to data_6. The payment server 208 may require the first, second, third, fourth, and sixth fields to process the transaction, with the fifth field being optional.

The API 202 may provide a menu list to the application software 201 to allow a user to select the payment gateway to process the credit card transactions. When the selection is made, the connector corresponding to the gateway is set. When the merchant requests a credit card transaction, the application system 201 based on the merchant's payment gateway selection, communicates to the API 202 which connector to use. For example, if the merchant is using payment gateway_2, the application system 201 communicates to the API 202 that connector_2 is to be used for the credit card transaction. The API then communicates with the connector memory 208 to retrieve connector_2, and the data formatting information in connector_2 is forwarded to the application system 201. Based on the information contained in connection_2, the application system 201 quarries the merchant or the credit card user for the input fields for both the required and optional fields. In addition, the quarry may distinguish between the required and optional fields so that the data or value may be gathered efficiently and securely.

Each connector may be in the form of a software object that is used by the application system 201 to quarry the merchant or the credit card user. The software objects corresponding to the payment gateways may include software to format the inputted fields by the merchant and transmit the information to the corresponding payment gateways. That is, the software object may act as a messaging agent between the application system 201 and the corresponding payment gateway. Once the merchant inputs the required input fields, along with the optional input fields, if any, the application system 201 forwards the input fields contained in the software object to the API 202. The API then transmits the software object to the corresponding payment gateway for processing the transaction. The gateway then forwards the information to the payment processor 206, which then processes the information to either approve or deny the transaction. If the transaction is approved, then the information is forward to the back 208 to complete the transaction.

The connectors in the form of software objects may communicate with the plurality of payment gateways through TCP/IP protocol or any other method known to one skilled in the art. The communication may be made through the Internet or may be directly linked via a dedicated hard line, wirelessly, or any other method known to one skilled in the art.

With the above interfacing system 200, the merchant can switch to another payment gateway by selecting the desired payment gateway from the menu list provided by the API 202. The merchant may also process the transaction through a particular payment gateway based on a predetermined condition established by the merchant. For instance, the merchant may set up a condition within the application system 101 where: if the credit card transaction is less than or equal to $100, then the payment gateway 206 is used, and for all other transactions, the payment gateway 208 is used. Such dual transaction condition may allow the merchant to take advantage of the fee arrangement offered by the competing payment gateways, where one payment gateway offers a better fee arrangement for transactions less than or equal to $100, and another payment gateway offers a better fee arrangement for transactions above $100.

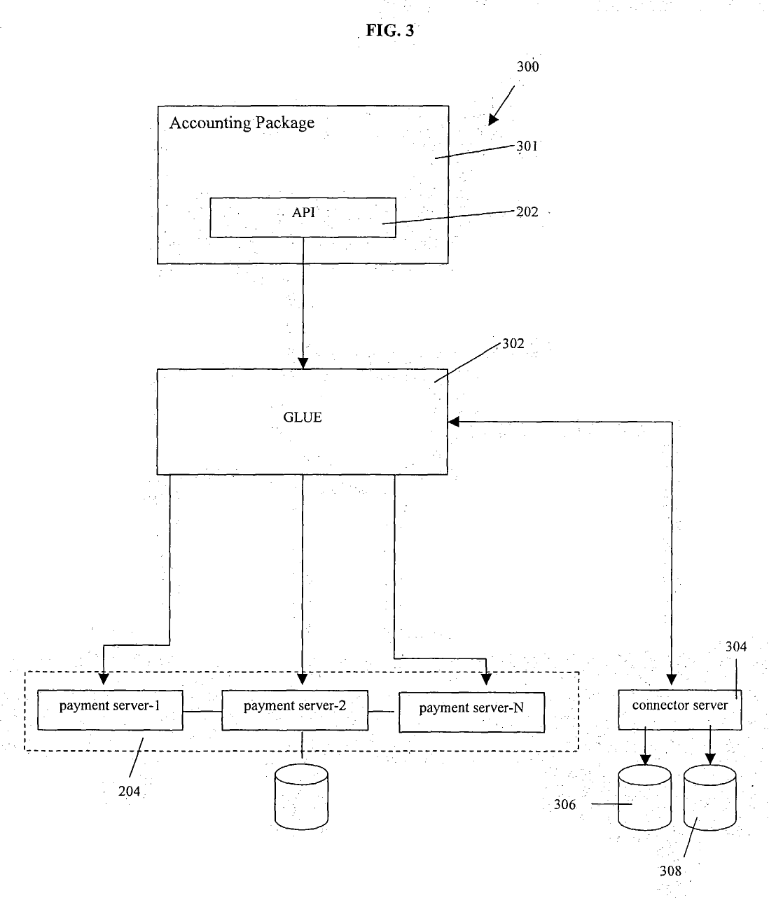

FIG. 3 illustrates that the application system 201 may be an accounting package 301, which requires the API 202 to operate within the accounting package 301. The accounting package such as Microsoft Great Plains® may not be able to communicate directly with the plurality of payment gateways 204. To facilitate the communication, glue 302 may be provided to allow communication amongst the API 202, the plurality of payment-gateways 204, and a connection server 304. The glue 302 may be a dynamic link library (DLL) with executable functions that can be used by the accounting package. The DLL may act as a wrapper to provide compatibility between the accounting package 301 and the plurality of payment gateways 204, and allow the API to communicate with the connection server 304 as well.

The connection server 304 may be communicateably coupled to a connector memory 306 that stores data formatting information for each of the plurality of connectors supported by the API 202. In addition, the connector memory 306 may distinguish between required fields and optional fields, if any. The connection memory 30 may provide the data formatting requirements in the form of Extensible Markup Language (XML), which allows programmers to create their own customized tags, enabling the definition, transmission, validation, and interpretation of data between applications. This way, if there are any changes or updates on the data formatting requirements for a payment gateway, the XML corresponding to the payment gateway may be changed rather than recoding and reconfiguring the fields that were hard coded into the software.

The connection server 304 may also be communicateably coupled to a template memory 308. Each payment gateway may have a unique style in terms of look and feel of the template screen. For instance, the type of font and font size may be different for each of the payment gateways. The template memory 308 may have a particular template formatting requirement for each of the payment gateways. The template memory 308 may provide the template requirement in the form of Extensible Style Language (XSL), which is a specification for separating style from content when creating Hyper Text Markup Language (HTML) or XML pages.

Once the API 202 is installed within the accounting package 301, a user may select at least one connector corresponding to a particular payment gateway from the menu list provided by the API 202. When a customer is ready to process a transaction using a credit card, based on the connector selected by the user, the accounting package 301 communicates to the API 202 the connector to use for the transaction. The API 202 communicates with the connector server 304 the connector that is being used for the transaction. Based on the connector, the connector server 304 retrieves from the connector memory 306 the data formatting requirements for the payment gateway corresponding to the connector. The connector memory 306 may provide the data formatting requirements to the connector server 304 in the form of XML. The connector server 304 may also retrieve the template formatting requirements for the payment gateway corresponding to the connector. The template memory 308 may provide the template formatting requirements in the form of XSL. The connector server 304 forwards the data and template formatting requirements to the API 202. The API 202 forwards the data and template formatting requirements into HTML to the accounting package 301 to quarry the user for the required and optional fields with the right style as dedicated by the template formatting requirements. The quarry for the required fields may be distinguished from the optional fields so that the user may input data for the optional fields if desired. After the user inputs the required and optional fields, the API 202 forwards the correctly formatted data to the payment gateway corresponding to the connector to process the transaction.

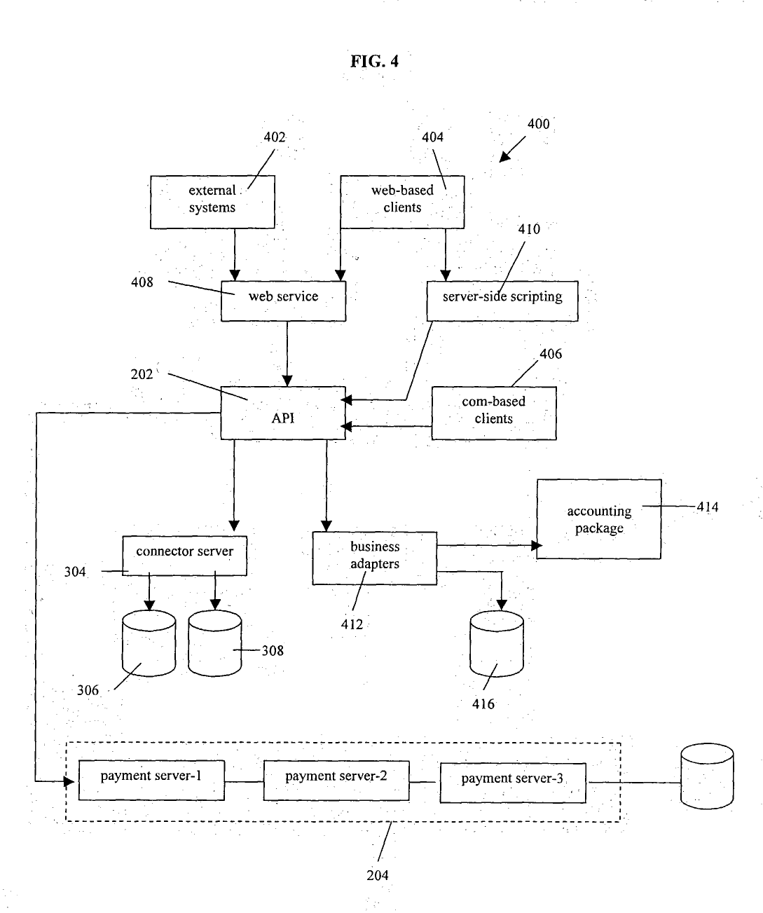

FIG. 4 illustrates an interfacing system 400 including the API 202 capable of processing credit card transactions for merchants using different application software or systems to process the transactions. Merchants may use a variety of application systems such as an external system 402, web-based system 404, .COM based system 406, or any other system known to one skilled in the art. The external system 402 may be any type of a software application that is running on a remote server that processes credit card transactions. The external system 402 running on the remote server may communicate with the API through a web server 408. The web server 202 may run on top of the API 202 to provide additional support for accessing the API 202 using simple object access protocol (SOAP)/XML. The web server 408 may be used by both Windows® and non-windows based application software or systems that support SOAP.

The API 202 may be also accessed by the web-based system 404 such a shopping cart system or a storefront that allows a customer to purchase a good or service through the web access. The web-based system 404 may communicate with the API 202 through the server-side scripting 410. In instances where the web-based system 404 is based on .NET, the web-based system 404 may communicate with the API 202 through the web server 408. The .COM based system 406 such as a point-of-sales system that operates within the same server as the API 202 may communicate directly with the API 202. Accordingly, a variety of application software or systems such as point-of-sales, business-to-business portals, call centers, enterprise resource planning (ERP), or customer relationship management (CRM) systems may directly or indirectly communicate with the API 202 to process not only credit card transactions but other transactions as well.

The API 202 may also communicate with a business adapter 412 that provides connection to external systems that may use the data in the transaction for accounting or for record keeping. For instance, the business adapter 412 may forward the data corresponding to the transaction to an accounting package 414 to record and keep track of the transaction. The business adapter 412 may also forward the data corresponding to the transaction to a memory bank 416 for storing the data for later use.

Once a connector is selected for processing the transaction, the application system is ready to process transactions. For instance, if the merchant hosting the web-based system 404 has selected connector_1 corresponding to payment gateway_1 to process the transaction, and a client is ready to purchase the items in the shopping cart by initiating a checkout button on the web page, the web-based system 404 communicates to the API 408 to process the checkout transaction using connector_1. The web-based system 404 may communicate with the API 202 either through the web service 408, server-side scripting 410, or any other method known to one skilled in the art. The API 202 then retrieves the input field requirements for connector_1 from connector memory 306. The input field requirements may include required fields and optional fields. The API 202 may then format the input field requirements into a HTML and forward the HTML to the web-based system 404 to display the web-page with required and optional input fields for the client to provide.

Once the client is done inputting the required and the optional input fields, if any, the API 202 retrieves the inputted data and forwards the data to the payment gateway corresponding to connector_1, which in this example is payment gateway_1. The inputted data from the client is correctly formatted for payment gateway_1 because the quarry to the user was based on the data formatting requirements of connector_1. The payment processor then either approves or denies the transaction. If the transaction is approved, then the data is sent to the bank to complete the transaction. The API 202 may also send the data to the business adapter to forward the data to the memory bank 416 and/or accounting package 414 to keep record of the transaction.

In closing, it is noted that specific illustrative embodiments of the invention have been disclosed hereinabove. However, it is to be understood that the invention is not limited to these specific embodiments. For example, the invention is applicable for electronic check and ACH transactions. With respect to the claims, it is the applicant's intention that the claims not be interpreted in accordance with the sixth paragraph of 35 U.S.C. § 112 unless the term “means” is used followed by a functional statement.

1. A method for interfacing data between a first software and a second software to process a transaction between the first software and the second software, the method comprising:
determining the data needed for processing a transaction from the second software by the first software;
requesting the data from a client; and
processing the transaction using the data.

2. A method for making an electronic payment, comprising:
determining the data needed from a payment processor to make an electronic payment;
requesting the data from a client;
retrieving the data from the client; and
processing the data through the payment processor to make the electronic payment.

3. The method according to claim 2, where the data includes required information and optional information.

4. The method according to claim 2, where the client is a web-based client.

5. The method according to claim 2, where the data includes credit card information, electronic check, electronic cash, and electronic fund.

6. A method for interfacing merchant's credit card processing system with a plurality of payment processors, the method comprising:
determining the payment processor to be used from the plurality of payment processors for a credit card transaction;
retrieving the data needed to process the credit card transaction through the payment processor;
requesting the data from a client to process the credit card transaction through the payment processor; and
processing the data through the payment processor to process the credit card transaction.

7. The method according to claim 6, where the data includes both required data and optional data.

8. The method according to claim 7, further including reducing the credit card transaction fee if the merchant provides the optional data.

9. The method according to claim 6, further including, storing the credit card transaction into a memory.

10. The method according to claim 6, further including, transmitting the information associated with the credit card transaction to an accounting package.

11. The method according to claim 6, where the merchant's credit card processing system is a web-based merchant.

12. The method according to claim 6, where the merchant's credit card processing system is a point-of-sale merchant.

13. The method according to claim 6, further including, providing a template with input fields to the merchant's credit card processing system for the requesting of the data.

14. The method according to claim 7, further including, providing a template with input fields for the required data and the optional data to the merchant's credit card processing system for requesting the data.

16. A method for interfacing a merchant's payment processing system to a plurality of payment processors each having a plurality of input fields for completing a transaction, the method comprising:
determining the payment processor corresponding to the transaction from the plurality of payment processors;
determining whether each of the input fields for the payment processor is a required input field or an optional input field to process the transaction; and
requesting the required and optional input fields, if any, from a client through the merchant's payment processing system to process the transaction.

17. A method for processing a payment transaction between a merchant's payment processing system and a plurality of payment processors each having a plurality of input fields to process a transaction, the method comprising:
updating the plurality of input fields for each of the plurality of payment processors to process the transaction; and
determining whether each of the input fields for the plurality of payment processors is a required input field or an optional input field to process the transaction.

18. A system for interfacing a plurality of merchant's payment processing systems with a plurality of payment processors each having a plurality of input fields to process a plurality of payment transactions between the plurality of merchant's payment processing systems and the payment processors, the system comprising:
a memory storing the plurality of input fields for a predetermined number of payment processors, where the plurality of input fields include required and optional input fields, if any; and
a server capable of requesting from a merchant's payment processing system a payment processor to use to process a payment transaction and retrieving from the memory the required and optional input fields corresponding to the payment processor.

19. A system for interfacing a first software with a second software to process a transaction between the first and second software, the system comprising:
a memory storing first required and optional input parameters to process the transaction through the first software; and
a server capable of communicating with the memory to determine the first required and optional input parameters and acquiring from the second software the first required and optional input parameters, if any, to process the transaction from the second software to the first software.

20. The system according to claim 19, where the memory stores second required and optional input parameters to process the transaction through the second software, the server acquires from the first software the second required and optional input parameters, if any, to process the transaction from the first software to the second software.

21. A system for interfacing a first software with a second software to process a transaction between the first and second software, the system comprising:
a memory storing first required and optional input parameters to process a first transaction at the first software and storing second required and optional input field parameters to process a second transaction at the second software; and
a server capable of communicating with the memory to determine the first and second required and optional input parameters and acquiring the first required and optional input parameters from the second software and providing the first required and optional input parameters to the first software to process the first transaction, the server further capable of acquiring the second required and optional input parameters from the first software and providing the second required and optional input parameters to the second software to process the second transaction.
